(19) United States
(12) Patent Application Publication
(10) Pub. No.: US 2009/0252951 A1
(43) Pub. Date: Oct. 8, 2009

(54) Protective sheet for preventing scratches

(76) Inventors: Hidenori Ozaki, Sakado-shi (JP); Yosimi Saito, Sayama-shi (JP); Hiroaki Ishizawa, Kawagoe-shi (JP); Tsuyoshi Maeda, Nerima-ku (JP); Yoshiaki Kato, Chuo-ku (JP); Yu Isozaki, Edogawa-ku (JP)

Correspondence Address: FRISHAUF, HOLTZ, GOODMAN & CHICK, PC, 220 Fifth Avenue, 16TH Floor, NEW YORK, NY, 10001-7708, US

(21) Appl. No.: 12/309,211

(22) PCT Filed: Aug. 1, 2007
(86) PCT No.: PCT/JP2007/065476

§ 371 Date: Jan. 9, 2009

(30) Foreign Application Priority Data
Aug. 3, 2006 (JP) 2006-211646

(51) Int. Cl. B32B 27/30; B32B 3/26; B32B 37/02

(52) U.S. Cl. 428/319.3; 428/304.4; 156/256

(57) ABSTRACT

A protective sheet for preventing scratches which comprises a substrate (1) having one face exhibiting the self-sticking property and a foam rubber layer (3) disposed on the other face of the substrate (1) and, in particular, the protective sheet for preventing scratches described above which further comprises a sheet layer (5) which is disposed on the foam rubber layer (3) and exhibits releasing property from the face exhibiting the self-sticking property of the substrate (1). The protective sheet is used for protecting the surface of various articles, in particular, for preventing scratches on coated portions of panels of the body in the assembly step of vehicles. The protective sheet is characterized in that the sheet can be attached easily with excellent adhesion and detached easily, does not adversely affect the surface of the coated face, exhibits excellent property of following curved surfaces, water resistance, strength and cushioning property, and can be used repeatedly, produced at a low cost and applied to a wide range of articles.

### TECHNICAL FIELD

The present invention relates to a protective sheet for preventing scratches. More particularly, the present invention relates to a protective sheet for preventing scratches which is used for protecting the surface of various articles, in particular, for preventing scratches on coated portions of panels of the body in the assembly step of vehicles. The protective sheet is characterized in that the sheet can be attached easily with excellent adhesion and detached easily, does not adversely affect the surface of the coated face, exhibits excellent property of following curved surfaces, water resistance, strength and cushioning property, and can be used repeatedly, produced at a low cost and applied to a wide range of articles.

### BACKGROUND ART

In the assembly of vehicles such as four-wheel motor vehicles, the operations of assembly are conducted while body panels, in particular, portions susceptible to scratches such as external panels are covered with a protective cover such as a protective cover made of polyvinyl chloride.

However, many members for the body other than the external panels cannot be kept covered with the protective panel, and some portions in such members are susceptible to scratches. For example, lower corner portions of the outside panel forming the opening of a door in a four-wheel motor vehicle are susceptible to scratches during the working.

To overcome the problem, in Patent Reference 1, a protective cover for working in which a sheet made of a fabric is laminated to the back face of a sheet of a thermoplastic resin which is formed along the lower edge from the front corner to the rear corner at the lower side of the opening of a door in an outside panel of a four-wheel motor vehicle, is disclosed.

In this technology, when the sheet of a fabric is laminated, the sheet of a fabric are cut at portions so that the portions formed by the cutting have shapes fitting curved portions and curved faces of the protective cover for working. The portions formed by the cutting are bonded together with pressure sensitive adhesive tapes in the shaping step, and the obtained sheet of a fabric is attached to the back face of a thermoplastic sheet under a pressure and formed into a desired shape.

Fixing means for fixing the protective cover at necessary positions of the lower edge of the outside panel are attached, and the protective cover is fixed using the fixing means.

However, the protective cover described above requires fixing means for fixing the protective cover at the lower edge of the outside panel. Many operations are necessary for the working since the fixing means must be placed in advance, and it is inevitable that the cost of production is increased. When the operations for the assembly are completed, the fixing means must be removed at the time when the protective cover is detached, and the attachment and the detachment of the protective cover cause complicated operations.

To overcome the above problem, a cover for preventing scratches during operations for the assembly of a vehicle which comprises a sheet form flexible member formed into a sheet shape approximately along the outside shape of the portion for protection in a coated portion made of a metal other than the outside panel in the body panel and a magnet rubber adhered to necessary portions on the back face of the sheet form flexible member contacting the portion for protection, is disclosed (for example, refer to Patent Reference 2).

The above cover for preventing scratches during operations for the assembly of a vehicle is advantageous in that the portion for protection in the coated portions made of a metal in the body panel alone can be protected from scratches during the operations for the assembly, that the attachment and the detachment are easy, and that the cover is inexpensive. However, minutes pieces of metals tend to be attached to the portion of the magnet rubber, and there is the possibility that the body panel is damaged when the cover having the minute pieces of the metals is attached to the body panel. The cover has further problems in that durability and impact resistance are insufficient, and the article for the application is limited since the cover can be applied only when the article for the application is a magnetic substance.

In general, it is required for a protective sheet for preventing scratches that the sheet can be attached easily with excellent adhesion and detached easily, does not adversely affect the surface of the coated face, exhibits excellent property of following curved surfaces, water resistance, strength and cushioning property, and can be used repeatedly, produced at a low cost and applied to a wide range of articles.

[Patent Reference 1] Japanese Patent No. 3001886

[Patent Reference 2] Japanese Patent Application Laid-Open No. 2003-341565

### DISCLOSURE OF THE INVENTION

Under the above circumstances, the present invention has an object of providing a protective sheet for preventing scratches which is used for protecting the surface of various articles, in particular, for preventing scratches on coated portions made of a metal or coated portions made of a resin in panels of the body in the assembly step of vehicles, satisfies the required properties described above and can be applied to a wide range of articles.

As the result of intensive studies by the present inventors to develop the protective sheet for preventing scratches exhibiting the advantageous properties described above, it was found that the above object could be achieved with a protective sheet which comprised a substrate having one face exhibiting the self-sticking property and a foam rubber layer and, occasionally, a sheet layer exhibiting a specific property which were disposed successively on the other face of the substrate. The present invention has been completed based on the knowledge.

The present invention provides:

(1) A protective sheet for preventing scratches which comprises substrate (A) having one face exhibiting self-sticking property and foam rubber layer (B) disposed on other face of substrate (A);
(2) The protective sheet for preventing scratches described in (1), which comprises sheet layer (C) which is disposed on foam rubber layer (B) and exhibits releasing property from the face exhibiting self-sticking property of substrate (A);
(3) The protective sheet for preventing scratches described in (2), wherein a member exhibiting an adhesive force under 180 degree peeling (releasing force) of 150 mN/25 mm or smaller is used as a member constituting sheet layer (C), the releasing force being measured in accordance with a method of Japanese Industrial Standard Z 0237 after the member constituting sheet layer (C) is placed on a member constituting substrate (A) in a manner such that a front face of the member constituting sheet layer (C) is faced to the face exhibiting self-sticking property of the member constituting substrate (A), and an obtained test piece is left standing in an environment of 23° C. and 50% RH under a load of 19.6 N for 3 hours;
(4) The protective sheet for preventing scratches described in any one of (2) and (3), wherein the member constituting sheet layer (C) is a sheet form fabric obtained by using an organic fiber;
(5) The protective sheet for preventing scratches described in any one of (1) to (4), wherein the self-sticking property exhibited by substrate (A) is based on physical sticking property or sticking property of a raw material itself;
(6) The protective sheet for preventing scratches described in (5), wherein the physical sticking property is based on a structure having cellular sucking disks;
(7) The protective sheet for preventing scratches described in (6), wherein substrate (A) exhibiting self-sticking property comprises a layer having cellular sucking disks made of an acrylic resin disposed on a support;
(8) The protective sheet for preventing scratches described in any one of (1) to (7), wherein foam rubber layer (B) is a layer of a urethane foam rubber;
(9) The protective sheet for preventing scratches described in one of (1) to (8), wherein, an adhesive force under 180 degree peeling (sticking force) is in a range of 50 to 200 mN/25 mm or smaller, the sticking force being measured in accordance with a method of Japanese Industrial Standard Z 0237 after substrate (A) of the protective sheet for preventing scratches is placed on a steel plate having a urethane-based coating film in a manner such that the face exhibiting self-sticking property of substrate (A) is faced to the steel plate, substrate (A) and the steel plate are pressed to each other by rolls under a load of 19.6 N in an environment of 23° C. and 50% RH, and an obtained test piece is then left standing for 3 hours in an environment of 23° C. and 50% RH; and
(10) The protective sheet for preventing scratches described in any one of (1) to (9), which is used in an assembly step of vehicles.

### BRIEF DESCRIPTION OF THE DRAWINGS

FIG. 1 shows a schematic sectional view exhibiting the construction of an example of the protective sheet for preventing scratches of the present invention.

In the Figures, 1 means a support, 1a means a support, 1b means a layer exhibiting the self sticking property, 2 and 4 mean a pressure sensitive adhesive (adhesive) layers, 3 means a foam rubber layer, 5 means a sheet layer, 6 means a release sheet, and 10 means a protective sheet for preventing scratches.

### THE MOST PREFERRED EMBODIMENT TO CARRY OUT THE INVENTION

The protective sheet for preventing scratches (referred to briefly as the protective sheet, occasionally) of the present invention has a structure which comprises substrate (A) having one face exhibiting the self-sticking property, foam rubber layer (B) disposed on the other face of substrate (A) and, occasionally, sheet layer (C) which is disposed on foam rubber layer (B) and exhibits the releasing property from the face exhibiting the self-sticking property of substrate (A).

In the present invention, the self-sticking property means the sticking property exhibited by the sticking mechanism of the substrate itself without depending on a sticking mechanism of a third member such as a pressure sensitive adhesive, an adhesive or a magnet.

In the protective sheet of the present invention, as the substrate having one face exhibiting the self-sticking property used as substrate (A), any of sheet form substances exhibiting the physical sticking property and sheet form substances in which the raw material itself exhibits the sticking property can be used. In the present invention, the sheet form substance means both of a film and a sheet.

Examples of the sheet form substance exhibiting the physical sticking property include sheet form substances in which the surface layer has a structure having cellular sucking disks. As the sheet form substances in which the surface layer has a structure having cellular sucking disks, sheet form substances in which at least the surface layer is a layer of a foamed material exhibiting the sticking property can be used. In this case, it is sufficient that the surface layer is the layer of a foamed material exhibiting the sticking property, and it is not necessary that the entire sheet form substance is the foamed material exhibiting the sticking property. Naturally, the entire sheet form substance may be a foamed material exhibiting the sticking property. In other words, the above sheet form substance may be a substance formed by disposing a layer of a foamed material exhibiting the sticking property on a suitable support or a sheet form substance of a foamed material exhibiting the sticking property.

The foamed material exhibiting the sticking property is not particularly limited as long as the surface has a sucking disk structure having an opening connected to the outside. Any of materials having the open cell structure and materials having the closed cell structure may be used. Examples of the foamed material having the open cell structure include foamed materials described in Japanese Patent Application Laid-Open No. Heisei 1(1989)-259043. The above foamed material is a foamed material in which the surface at the side to be attached to an article is a flat and continuous surface of a resin having minute pores, the minute pore has a structure such that the minute pore is connected to an inner pore having a diameter greater than the diameter of the minute pore, the cell at the inside is connected to other cells via thin tubes, and the continuous layer of a resin is made of a synthetic resin. The flat and continuous surface of a resin having minute pores means a structure in which minute pores having a shape such as a shape formed by perforation are approximately uniformly distributed on a plastic sheet. The diameter of the minute pores and the fraction of pores are not particularly limited. From the standpoint of the property for fixing to an article by sticking, it is preferable that the average diameter of the minute pores is 50 μm or smaller and the fraction of pores is about 5 to 25%. The average diameter of the cells at the inside which are present closer to the center than the surface layer is greater than the average diameter of the minute pore at the surface described above and is preferably 1.5 to 5 times as great as the average diameter of the minute pore at the surface.

The synthetic resin constituting the foamed material exhibiting the sticking property is not particularly limited. Examples of the synthetic resin include phenyl resins, urethane resins, acrylic resins, polyester resins, polyolefin resins, fluororesins, polyacetal resins, epoxy resins, alkyd resins and butadiene-based synthetic rubbers. The synthetic resin may be used singly or in combination of two or more.

Among the above synthetic resins, urethane resins, acrylic resins and butadiene-based synthetic rubbers are preferable, and acrylic resins are more preferable.

For producing the layer comprising the foamed material exhibiting the sticking property or the sheet form substance comprising the foamed material exhibiting the sticking property, it is preferable that the synthetic resin such as that described above as the example is used in the form of an emulsion. The content of the synthetic resin in the emulsion is, in general, about 30 to 60% by mass. Various additives such as crosslinking agents, foaming agents, foam stabilizers, viscosity controllers, coloring agents, fillers, antioxidants and antimicrobial agents are added to the emulsion of the synthetic resin, where necessary. Then, the resultant mixture is mixed with the air using a mechanical foaming machine, and a foaming emulsion containing bubbles is prepared. The layer comprising the foamed material exhibiting the sticking property can be prepared by coating a support with the prepared emulsion, followed by the heat treatment of the formed coating layer. The sheet form article comprising the foamed material exhibiting the sticking property can be prepared by forming the foamed material on a release paper or in a frame exhibiting the releasing property, followed by removing the paper or the frame. In accordance with the above process, the layer comprising the foamed material exhibiting the sticking property or the sheet form substance comprising the foamed material exhibiting the sticking property which has the desired cellular structure can be obtained by selecting the conditions in the steps of mixing, mechanical foaming, coating and heat treatment.

The foaming emulsion can also be prepared by adding microcapsules exhibiting the property of expansion by heating in which a suitable synthetic resin such as a vinylidene chloride copolymer is used as the shell and a hydrocarbon-based compound having a low boiling point is contained in the shell to an emulsion of an acrylic resin or an emulsion of a synthetic rubber, in place of using the mechanical foaming described above.

When substrate (A) is a substance having the layer comprising the foamed material exhibiting the sticking property described above disposed on the surface of a support, for example, a paper substrate, a synthetic paper or a plastic sheet can be used as the support. Examples of the paper substrate include fine paper, art paper coated paper, craft paper and laminate paper prepared by laminating a thermoplastic resin such as polyethylene on a substrate. The synthetic paper is a sheet having the surface formed into paper using a combination of a thermoplastic resin and inorganic fillers. Examples of the synthetic paper include synthetic papers based on polyolefin-based resins, polystyrene-based resins, polyvinyl chloride-based resins and polyester-based resins. Examples of the plastic sheet include sheets comprising polyolefin-based resins such as polyethylene, polypropylene and various types of olefin-based copolymers, polyester-based resins such as polyethylene terephthalate and polyethylene naphthalate, polystyrene-based resins, polyvinyl chloride-based resins, acrylic resins, polycarbonate-based resins, polyamide-based resins, fluororesins such as polytetrafluoroethylene and mixture of these resins and laminates comprising these sheets. Among these sheets, sheets comprising polyethylene terephthalate are preferable.

In the case of the substrate comprising the foamed material exhibiting the sticking property described above disposed on the surface of a support, the thickness of the entire substrate is, in general, 100 to 1,000 μm and preferably 200 to 600 μm, and the thickness of the layer of the foamed material is, in general, 70 to 900 μm and preferably 300 to 500 μm.

When the substrate is the sheet form substance comprising the foamed material exhibiting the sticking property, the thickness of the substrate is, in general, 100 to 1,000 μm and preferably 200 to 600 μm.

Examples of the foamed material having the closed cell structure include foamed materials obtained by chemically foaming a synthetic resin material such as an acrylic resin, an ethylene-vinyl acetate resin, styrene-butadiene rubber and natural rubber or a rubber material on the support described above to form the layer of the foamed material exhibiting the sticking property. In this case, the thickness of the entire substrate and the thickness of the layer of the foamed material are the same as those described above for the foamed materials having the open cell structure.

Examples of the sheet form substance in which the raw material itself exhibits the self-sticking property include materials obtained by forming a layer of a synthetic resin material exhibiting a great resistance of friction and excellent releasing property on the support. The above layer can be formed, for example, by using a pressure sensitive adhesive which comprises an acrylic resin-based emulsion or a styrene-butadiene-copolymer-based emulsion and an agent for improving the releasing property. Examples of the agent for improving the releasing property include olefin-based polymers having a softening point of about 100 to 150° C. such as polyethylene, polypropylene, polybutene, ethylene copolymers and mixtures of these polymers. A crosslinking agent may be added to the acrylic resin-based emulsion or the styrene-butadiene copolymer-based emulsion used as the base material so that the sticking property can be adjusted. A pressure sensitive adhesive which comprises an acrylic resin-based emulsion or a styrene-butadiene-copolymer-based emulsion and an agent for improving the releasing property (hereinafter, referred to as an emulsion coating fluid comprising an agent for improving the releasing property) can be prepared as described above.

The emulsion coating fluid comprising an agent for improving the releasing property prepared as described above is applied to the support described above and dried, and a sheet form substance in which the raw material itself exhibits the sticking property can be obtained.

As the substrate exhibiting the self-sticking property used in the present invention, the sheet form substance exhibiting the physical sticking property based on the structure having cellular sucking disks is preferable, and sheet form substances having a layer having cellular sucking disks made of an acrylic resin disposed on a support are more preferable.

As for the self-sticking force of substrate (A) having one face exhibiting the self-sticking property in the protective sheet of the present invention, it is preferable that the adhesive force under 180 degree peeling (the sticking force) is selected in the range of 50 to 200 mN/25 mm and more preferably 100 to 180 mN/25 mm, wherein the sticking force is measured in accordance with the method of Japanese Industrial Standard Z 0237 as described below after substrate (A) of the protective sheet is placed on a steel plate having a urethane-based coating film in a manner such that the face exhibiting the self-sticking property of substrate (A) is faced to the steel plate, substrate (A) and the steel plate are pressed to each other by rolls under a load of 19.6 N in the environment of 23° C. and 50% RH, and the obtained test piece is then left standing for 3 hours in an environment of 23° C. and 50% RH. When the sticking force is in the above range, the protective sheet of the present invention can be attached to an article for the attachment with excellent adhesion, shift of the attached sheet and formation of peeled portions are suppressed, and the attached sheet can be detached easily.

In the protective sheet of the present invention, foam rubber layer (B) is disposed on the other face of substrate (A) having one face exhibiting the self-sticking property described above.

Examples of the foam rubber constituting layer (B) include foamed materials (foam rubbers) based on EPDM rubber (ethylene-propylene-diene rubber), urethane rubber, nitrite rubber, silicone rubber, chloroprene rubber, epichlorohydrin rubber, butadiene rubber, styrene-butadiene rubber, isoprene rubber, natural rubber, butyl rubber and acrylic rubber. Among these materials, foamed materials based on urethane rubber (urethane foam rubbers) are preferable from the standpoint of the property for forming sheets, the cushioning property and the property of following curved surfaces.

The thickness of the foam rubber layer is not particularly limited. The thickness is, in general, about 1 to 10 mm and preferably 2 to 8 mm from the standpoint of the cushioning property.

The foam rubber layer can be disposed on substrate (A) by using an adhesive or a pressure sensitive adhesive. As the adhesive, conventional adhesives comprising, for example, polyurethane-based resins, epoxy-based resins, acrylic resins, vinyl-based resins, vinyl acetate-based resins, polyester-based resins, ethylene-vinyl acetate copolymer-based resins or acrylic monomer-vinyl acetate copolymer-based resins, as the main component can be used. As the pressure sensitive adhesive, conventional pressure sensitive adhesives such as acrylic pressure sensitive adhesives, rubber-based pressure sensitive adhesives, silicone-based pressure sensitive adhesives and polyester-based pressure sensitive adhesives can be used.

The protective sheet of the present invention may comprise sheet layer (C) which is disposed on foam rubber layer (B) and exhibits the releasing property from the face exhibiting the self-sticking property of substrate (A) (hereinafter, referred to as sheet layer (C), occasionally).

When the protective sheet is recovered and reused after being used for protection of various articles such as a body panel in the assembly step of a vehicle, many recovered protective sheets are frequently stacked for transportation or storage in a manner such that one sheet is placed on top of another. When the protective sheet is constituted with substrate (A) and foam rubber layer (B) alone, the self-sticking face of substrate (A) and the surface of foam rubber layer (B) are brought into contact with each other in the above operation, and a problem arise in that separation of one protective sheet from another protective sheet for the reuse is difficult.

The above problem can be overcome by disposing a sheet layer exhibiting the releasing property on foam rubber layer (B).

In the present invention, it is preferable that a member exhibiting an adhesive force under 180 degree peeling (a releasing force) of 150 mN/25 mm or smaller, more preferably 100 mN/25 m or smaller and most preferably 50 mN/15 mm or smaller is used as the member constituting sheet layer (C), wherein the releasing force is measured in accordance with the method of Japanese Industrial Standard Z 0237 after the member constituting sheet layer (C) is placed on a member constituting substrate (A) in a manner such that the member constituting sheet layer (C) is faced to the face exhibiting the self-sticking property of the member constituting substrate (A), and the obtained test piece is left standing in the environment of 23° C. and 50% RH under a load of 19.6 N for 3 hours. The above problem can be easily overcome by using sheet layer (C) described above.

As the above member constituting sheet layer (C), a sheet form fabric such as a woven fabric, a knitted fabric and a non-woven fabric obtained by using an organic fiber can be used. The raw material for the sheet form fabric is not particularly limited. Examples of the raw material for the sheet fabric include natural fibers and semi-synthetic fibers such as cotton, jute, cellulose fibers and rayon fibers; and synthetic fibers such as nylon fibers, aromatic polyamide fibers, polyester fibers, polypropylene fibers, polyethylene fibers and acrylic fibers.

The thickness of the sheet form fabric is not particularly limited. The thickness is, in general, in the range of 30 to 200 g/m² and preferably in the range of 50 to 150 g/m².

When a woven fabric is used as the sheet form fabric, the texture of the fabric is not particularly limited and may be any of basic textures such as the plain stitch, the diagonal cloth and the satin weave and various textures derived from the basic textures. When a nonwoven fabric is used, the process for preparing the nonwoven fabric is not particularly limited, and a nonwoven fabric obtained in accordance with any of conventional processes such as the heat bonding process, the spun bonding process, the needle punching process and the wet process can be used.

As the process for forming sheet layer (C) on foam rubber layer (B) in the protective sheet of the present invention, for example, the sheet layer may be formed on the foam rubber layer using the adhesive or the pressure sensitive adhesive described above. As another example of the process, the constituting member of the sheet layer such as a sheet form fabric material made of an organic fiber is brought into contact with the foam rubber during the production of the foam rubber to produce a laminate in which the sheet form fabric material is integrally adhered to one face of the foam rubber, and the face of the foam rubber of the laminate is adhered to the face of substrate (A) opposite to the self-sticking face with the adhesive or the pressure sensitive adhesive.

It is preferable that the protective sheet of the present invention having the above construction exhibits an adhesive force under 180 degree peeling (a sticking force) in the range of 50 to 200 mN/25 mm or smaller, wherein the sticking force is measured in accordance with the method of Japanese Industrial Standard Z 0237 after substrate (A) of the protective sheet for preventing scratches is placed on a steel plate having a urethane-based coating film, substrate (A) and the steel plate are pressed to each other by rolls under a load of 19.6 N in the environment of 23° C. and 50% RH, and the obtained test piece is then left standing for 3 hours in the environment of 23° C. and 50% RH. When the sticking force is in the above range, the protective sheet of the present invention can be attached to an article for the attachment excellently, shift of the attached sheet and formation of peeled portions are suppressed, and the attached sheet can be easily detached. It is more preferable that the sticking force is 100 to 180 mN/25 mm.

The protective sheet of the present invention may comprise a release sheet disposed on the self-sticking face of substrate (A) so that contamination can be prevented.

Examples of the release sheet include release sheets obtained by coating paper substrates such as glassine paper, coated paper and cast coated paper, laminate papers obtained by laminating a thermoplastic resin such as polyethylene to the paper substrate and plastic films examples of which include polyester films such as films of polyethylene terephthalate, polybutylene terephthalate, polyethylene naphthalate and polyolefin films such as films of polypropylene and polyethylene, with a releasing agent such as silicone resins; and release sheets in which the raw material itself exhibits the releasing property such as crystalline polypropylene films and polyethylene films. The thickness of the release sheet is not particularly limited. The thickness is, in general, about 15 to 150 μm.

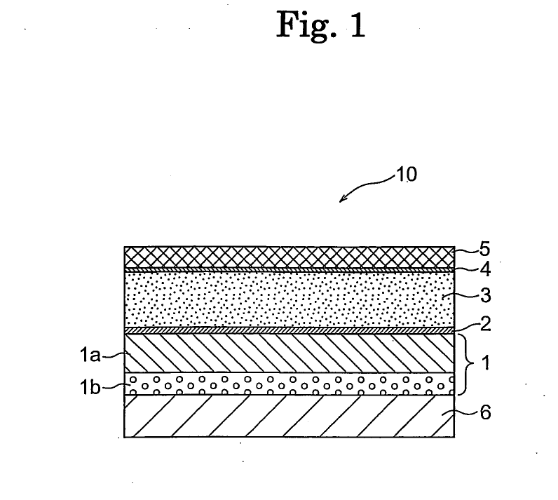

FIG. 1 shows a schematic sectional view exhibiting the construction of an example of the protective sheet for preventing scratches of the present invention. The protective sheet for preventing scratches 10 has the structure such that a substrate 1 has a support 1a having a self-sticking layer 1b on one face; a foam rubber layer 3 is disposed on the face of the substrate 1 opposite to the face having the self-sticking layer via a pressure sensitive adhesive (adhesive) layer 2; on the above substrate, a sheet layer 5 as the face layer is disposed via a pressure sensitive adhesive (adhesive) layer 4; and a release sheet 6 is disposed on the self-sticking layer 1b of the substrate 1, where desired.

The protective sheet for preventing scratches of the present invention is used for protecting surfaces of various articles, in particular, in the assembly step of vehicles. Specifically, the protective sheet for preventing scratches is advantageously used for preventing scratches on coated portions made of metals and coated portions made of resins in panels of the body of vehicles such as front outside panels forming the opening of the front door in four-wheel motor vehicles.

When the protective sheet for preventing scratches of the present invention is used for the first time, it is sufficient that, after the protective sheet is cut into an approximate shape of the article for protection, the release sheet is removed, and the protective sheet is attached to the article by bringing the self-sticking face into contact with the article for protection. After the operations in the step are completed, the attached sheet is recovered by peeling the sheet manually.

The recovered protective sheet is placed on top of another recovered sheet in a manner such that the self-sticking face of the protective sheet is brought into contact with the front layer of the other protective sheet so that the recovered protective sheet can be reused. Many recovered sheets are stacked up, stored and transported in the manner described above.

The protective sheet stacked up as described above can be separated into individual sheets easily when the sheets are reused.

The protective sheet for preventing scratches of the present invention exhibits the following advantages.

(1) Since the face for attachment to an article for the attachment is the self-sticking face, the protective sheet can be attached easily to the article for the attachment with excellent adhesion without shift of the attached sheet or formation of peeled portions. The attached sheet can be detached easily, and no adverse effects are exhibited on the coated face of the article for the attachment.
(2) Since the sheet exhibiting the releasing property from the self-sticking face is used for the front layer, many recovered protective sheets can be stacked up for the reuse and can be separated into individual sheets after storage or transportation.
(3) The protective sheet exhibits the excellent property for following curved surfaces, water resistance and cushioning property and is excellent as the protective sheet.
(4) The cost of production is low, and the protective sheet can be applied to a wide range of articles.
(5) When the recovered protective sheet is reused, a contaminated self-sticking face can be easily cleaned by washing with water or by wiping with a wet cloth.

In the present invention, the sticking force used for evaluation of the sticking property of the self-sticking face of the protective sheet for preventing scratches or substrate (A) as the component of the protective sheet and the peeling force used for evaluation of the releasing property of sheet layer (C) from the self-sticking face of substrate (A) are measured in accordance with the following methods.

### (a) Sticking Force

A sheet obtained by removing the release sheet from substrate (A) or a protective sheet for preventing scratches is cut into a piece having a width of 25 mm and a length of 250 mm, and the obtained piece is used as the test piece. A portion of the self-sticking face of the test piece having about a half the length of the test piece is pressed by a roller to a steel plate having a urethane-based coating film having a width of about 50 mm and a length of about 125 mm in the environment of 23° C. and 50% RH under a load of 19.6 N. After the test piece is left standing for 3 hours in the environment of 23° C. and 50% RH, the adhesive force under 180 degree peeling is measured in accordance with the method of Japanese Industrial Standard Z 0237, and the obtained adhesive force is used as the sticking force.

### (b) Releasing Force

Foam rubber layer (B) having laminated sheet layer (C) is cut into a piece having a width of 25 mm and a length of 250 mm, and the obtained piece is used as the test piece. Separately, substrate (A) or a protective sheet for preventing scratches is cut into a size of a width of 50 mm and a length of 125 mm. The back face of the obtained piece is fixed to the surface of a flat steel plate having approximately the same size with a double sided pressure sensitive adhesive tape, and the release sheet is removed. The test piece obtained above is placed on the substrate (A) or a protective sheet prepared above in a manner such that a portion of the front side [the side having sheet layer (C)] of the test piece having a half of the length of the test piece is faced to the self-sticking face of substrate (A) or the protective sheet. After the resultant laminate is left standing in the environment of 23° C. and 50% RH under a load of 19.6 N for 3 hours, the adhesive force under 180 degree peeling is measured in accordance with the method of Japanese Industrial Standard Z 0237, and the obtained adhesive force is used as the releasing force.

### EXAMPLES

The present invention will be described more specifically with reference to examples in the following. However, the present invention is not limited to the examples.

### Example 1

As substrate (A) having one face exhibiting the self-sticking property, “ZEON AL SHEET” [a trade name; manufactured by NIPPON ZEON Co., Ltd.], in which a polyethylene terephthalate support (1a) having a thickness of 50 μm had a layer having a thickness of 400 μm having acrylic resin-based cellular sucking disks (1b), and a polypropylene film having a thickness of 30 μm as the release sheet (6) was laminated on the layer having cellular sucking disks, was used. The sticking force obtained in accordance with the following method was 155 mN/25 mm.

On the face of the support in “ZEON AL SHEET” described above, a layer (2) of a pressure sensitive adhesive (an acrylic pressure sensitive adhesive; [manufactured by LINTEC Co., Ltd.; the trade name: “PA-T1”]) having a thickness of 30 μm was formed (refer to FIG. 1).

Then, on the face of a urethane foam rubber as foam rubber layer (B), a raw material sheet for wet suits having a thickness of 5 mm in which a circular knitted fabric made of nylon fiber was adhered [manufactured by SUN SYSTEM Company; the trade name: “#21HFK”; the tensile strength and the elongation measured in accordance with the method of Japanese Industrial Standard K 6251: 688 kPa and 470%, respectively; the hardness: 35HS (measured by using TYPE-CSC2 hardness meter manufactured by KOBUNSHI KEIKI Co., Ltd.); the apparent specific gravity: 0.25] as sheet layer (C) was laminated on the pressure sensitive adhesive layer formed on “ZEON AL SHEET” in a manner such that the above sheet was faced to the face of the urethane foam rubber, and a protective sheet for preventing scratches was formed.

The releasing force of the front face side of the circular knitted fabric in the raw material sheet for wet suits from the layer of cellular sucking disks in “ZEON AL SHEET” obtained in accordance with the following method was 1 mN/25 mm.

Using the protective sheet for preventing scratches prepared as described above, the sticking force and the effect on the coated surface were evaluated in accordance with the following methods.

As the result of the evaluation, the sticking force was 135 mN/25 mm, and no changes were found on the appearance of the coated surface under any of the conditions of 10° C. for 3 hours, 23° C. for 3 hours, 35° C. for 3 hours and 35° C. for 72 hours.

### (1) Method of Measurement of the Sticking Force of “ZEON AL SHEET” and a Protective Sheet for Preventing Scratches

A sheet obtained by removing the release sheet was cut into a piece having a width of 25 mm and a length of 250 mm, and the obtained piece was used as the test piece. A portion of the self-sticking face of the test piece having about a half the length of the test piece was pressed by a roller to a steel plate having a urethane-based coating film having a width of about 50 mm and a length of about 125 mm in the environment of 23° C. and 50% RH under a load of 19.6 N. After the test piece was left standing for 3 hours in the environment of 23° C. and 50% RH, the adhesive force under 180 degree peeling was measured in accordance with the method of Japanese Industrial Standard Z 0237, and the obtained adhesive force is used as the sticking force.

### (2) Effects on the Coated Surface

A protective sheet from which the release sheet had been removed was cut into a size of 50 mm×110 mm and pressed to a steel plate having a urethane-based coating film by a squeegee under a load of 19.6 N. Samples obtained in this manner were left standing under the conditions of 10° C. for 3 hours, 23° C. for 3 hours, 35° C. for 3 hours and 35° C. for 72 hours. Then, the protective sheet was peeled off manually, and the effect on the coated surface was confirmed by visual observation.

### (3) Method of Measurement of Sticking Force (Peeling Force) of the Front Face of Circular Knitted Fabric in a Raw Material Sheet for Wet Suits to the Layer Having Cellular Sucking Disks in “ZEON AL SHEET”

“ZEON AL SHEET” was cut into a size of a width of 50 mm and a length of 125 mm. The back face [the side of support (1a)] of the obtained piece was fixed to the surface of a flat steel plate having approximately the same size with a double sided pressure sensitive adhesive tape, and the release sheet was removed. The laminate prepared as described above was placed oh a raw material sheet for wet suits (the width: 25 mm; the length: 250 mm) in a manner such that the face of the layer having cellular sucking disks of “ZEON AL SHEET” was faced to the side of the circular knitted fabric of a portion of the raw material sheet of the circular knitted fabric for wet suits having about a half the length of the sheet. After the resultant laminate was left standing in the condition of 23° C. and 50% RH under a load of 19.6 N for 3 hours, the adhesive force under 180 degree peeling was measured in accordance with the method of Japanese Industrial Standard Z 0237, and the obtained adhesive force was used as the releasing force.

### INDUSTRIAL APPLICABILITY

The protective sheet for preventing scratches of the present invention is characterized in that the sheet can be detached easily, does not adversely affect the surface of the coated face, exhibits excellent property of following curved surfaces, water resistance, strength and cushioning property, and can be used repeatedly, produced at a low cost and applied to a wide range of articles. Therefore, the protective sheet is used for protecting surfaces of various articles, in particular, in the assembly step of vehicles. Specifically, the protective sheet is advantageously used for preventing scratches on coated portions made of metals and coated portions made of resins in panels of the body of vehicles such as front outside panels forming the opening of the front door in four-wheel motor vehicles.

1. A protective sheet for preventing scratches which comprises substrate (A) having one face exhibiting self-sticking property and foam rubber layer (B) disposed on other face of substrate (A), wherein a sheet layer (C) is further disposed on foam rubber layer (B) and said layer (C) exhibits releasing property from the face exhibiting self-sticking property of substrate (A).

2. (canceled)

3. The protective sheet for preventing scratches according to claim 1, wherein a member exhibiting an adhesive force under 180 degree peeling (releasing force) of 150 mN/25 mm or smaller is used as a member constituting sheet layer (C), the releasing force being measured in accordance with a method of Japanese Industrial Standard Z 0237 after the member constituting sheet layer (C) is placed on a member constituting substrate (A) in a manner such that a front face of the member constituting sheet layer (C) is faced to the face exhibiting self-sticking property of the member constituting substrate (A), and an obtained test piece is left standing in an environment of 23° C. and 50% RH under a load of 19.6 N for 3 hours.

4. The protective sheet for preventing scratches according to claim 1, wherein the member constituting sheet layer (C) is a sheet form fabric obtained by using an organic fiber.

5. The protective sheet for preventing scratches according to claim 1, wherein the self-sticking property exhibited by substrate (A) is based on physical sticking property or sticking property of a raw material itself.

6. The protective sheet for preventing scratches according to claim 5, wherein the physical sticking property is based on a structure having cellular sucking disks.

7. The protective sheet for preventing scratches according to claim 6, wherein substrate (A) exhibiting self-sticking property comprises a layer having cellular sucking disks made of an acrylic resin disposed on a support.

8. The protective sheet for preventing scratches according to claim 1, wherein foam rubber layer (B) is a layer of a urethane foam rubber.

9. The protective sheet for preventing scratches according to claim 1, wherein, an adhesive force under 180 degree peeling (sticking force) is in a range of 50 to 200 mN/25 mm or smaller, the sticking force being measured in accordance with a method of Japanese Industrial Standard Z 0237 after substrate (A) of the protective sheet for preventing scratches is placed on a steel plate having a urethane-based coating film in a manner such that the face exhibiting self-sticking property of substrate (A) is faced to the steel plate, substrate (A) and the steel plate are pressed to each other by rolls under a load of 19.6 N in an environment of 23° C. and 50% RH, and an obtained test piece is then left standing for 3 hours in an environment of 23° C. and 50% RH.

10. (canceled)

11. A protective sheet according to claim 1, wherein a release sheet is disposed on the face exhibiting self-sticking property of substrate (A).

12. A method of protecting a surface of an article, wherein said method comprises:
providing an article for protection and a protective sheet for preventing scratches which comprises substrate (A) having one face exhibiting self-sticking property and foam rubber layer (B) disposed on other face of substrate (A), wherein a sheet layer (C) is further disposed on foam rubber layer (B) and said layer (C) exhibits releasing property from the face exhibiting self-sticking property of substrate (A),
cutting said protective sheet into an approximate shape of the article for protection, and
attaching the protective sheet to the article by bringing the self-sticking face into contact with the article for protection.

13. A method according to claim 12, wherein the article for protection is a panel of a body of a vehicle in an assembly step of the vehicle.
